(19) United States
(12) Patent Application Publication
(10) Pub. No.: US 2005/0077429 A1
(43) Pub. Date: Apr. 14, 2005

(54) Method for producing lateral ejection apparattii for helicopter or plane

(76) Inventor: Michael Lawrence Beauchamp, San Francisco, CA (US)

Correspondence Address: Michael Lawrence Beauchamp, 651 - B Minna Street, San Francisco, CA, 94103, US

(21) Appl. No.: 10/645,044

(22) Filed: Aug. 18, 2003

(51) Int. Cl. B64D 17/00

(52) U.S. Cl. 244/142

(57) ABSTRACT

An aircraft occupancy, here a helicopter with a seat chassis mounted on a set of rails of any type, ideally as I have demonstrated on load bearing triple monorails with one hundred sixty-eight circumventing roller trucks attached to the inner rails, an outer track box movable along the inner tracks, and a monorail supporting track with eighty-four roller trucks. Shown here in a side view with partial delineation of the mesh end cover Any seat chassis attached to the outer track box is ejectable along a lateral trajectory, perpendicular to the horizontal longitudinal axis of an aircraft, and guided out of the path of a failed aircraft during ejection flight by two bottom positioned tail fins slotted within the ejection monorails launcher platform legs. The seat chassis is enabled to eject laterally since a conventional hinged door is operational within a greater sliding door panel which pneumatic rockets at the top and bottom of the sliding door transverse the greater emergency sliding door panel including the interior fixed conventional hinge operational door out of the path of the seat chassis or chassis', attached to the outer track box towards the rear of the aircraft where the sliding greater panel is prevented from recoiling by a common latch catches. Dual airbags for positioning the legs and torso of an occupant for a safe emergency exit ejection are embedded or attached to the structure directly fore of the seat chassis. A second set of airbags, head, neck and chest protector are connected on both sides of the seat chassis, mandatory for safe lateral equal access emergency exit ejection. Three compartments for altitude appropriate parachutes and sensor fuse box for opening said desired chute. Including an interior side mounted blast shield and monorails inner tracks support to which a couple of rocket catapults are fixed by seals at their ignition points, holding the outer track box and seat chassis stationary between the inner tracks and supporting track.

### BACKGROUND OF THE INVENTION

1. Field of the Invention

The new invention relates to the method and devices of aircraft or theoretically, objects in motion, specifically improvements and advantages, which, allow for the first time all occupants of helicopters and planes to eject laterally and safely from a helicopter or plane.

2. Description of Prior Art

Until now the failing has been that occupant ejection was possible only on a horizontal and even longitudinal axis as in military fighter jets, leaving many thousands of individuals and parties without access to a timely means of emergency exit in the event of a helicopter or plane failure. Longitudinal ejection cannot provide for equal access to an emergency exit, because aircraft are built along the longitude, dictating the larger surface areas along the right and left latitude as the sole reasonable and safe area for emergency exits of equal access in a commercial airliner. All ejection devices until now as cited in the references are void of the ability to laterally eject a commercial aircraft or helicopter aircraft occupant to safety. Subsequently, the weight of an aircraft occupant is now placed directly on load bearing triple monorails being employed for the first time. The extent to which the lateral ejection aerodynamic tool re-orders design throughout the complete range of fields defining aerodynamics is not limited to but can be defined as affecting Pat. Nos. cited in the references, which will have to under go moderate structural changes, so that in (50) fifty years time, most of the international air fleet will possess lateral ejection equal access total occupant timely emergency exit access. Moreover the lateral ejection tool is sightable by utilizing an aiming mechanism directed by a mechanized gear console handle and swing arm barrel sight seat swivel; only when existing fuselage area allows; actuated by cylindrical telescoping hydraulic arms capable of realizing near perfect, or, perfect theoretical, lateral ejection respective of the real time forward motion (pressure) of a failed aircraft, by targeting preferred seat trajectories towards any quadrant within a sphere when right and left bipolar seat pairs are configured in a combat or high performance helicopter or plane; if said aiming mechanism operates independent of a robotic arm, which costs would perhaps become prohibitive except in luxury aircraft or military designs in an exemplary embodiment. The aiming mechanism can work by pushing and pulling the lateral ejection mechanism with attached seat chassis, swinging from a center console containing the blast shield and a swivel plate on which the triple monorails and seat are mounted. Practically, the lateral triple monorails may be mounted by bolts and welding to any seat portal and sighted to eject 90 degrees perpendicular to the horizontal longitudinal axis, or, sighted along the angle 4 to 6 degrees preferred aft of the perpendicular in order to avoid a failed aircraft roll; in accordance with the spirit of the lateral ejection objectives; again, depending upon area limitations imposed by existing aircraft occupancy design, the 90 degrees, right-angle can be the common sighting, and is shown here in the abstract and drawings installed in a corporate helicopter fuselage, sighted at 90 degrees with bottom mounted tail fins turned 4 to 6 degrees aft of the aircraft occupancy. Multiple altitude appropriate parachutes could be added to each seat chassis to advantage with this invention, especially in commercial airliners. In other words, the preferred embodiment and the most important considerations of the lateral ejection invention are described here, not the exciting design implications of the lateral ejection utility, I just described.

### SUMMARY OF THE INVENTION

Therefore, I have invented a method and stable mechanism by which accordingly all aircraft occupants of helicopters or planes are ejectable. The method of lateral ejection, which apparattii are produced by arranging any set of tracks or guide rails, here a set of load bearing triple monorail tracks with circumventing roller trucks often associated with skateboarding wheel “trucks”, arranged laterally on a right angle to each other, along the bottom underside and back of an aircraft occupant accommodation, here known as a seat chassis. The seat chassis preferred embodiment features a pair of circumventing roller trucks guided monorail tracks attached to the bottom underside of the chassis with a third monorail with circumventing roller trucks along the back and at a right angle to the bottom two monorails. The circumventing roller trucks insure stable ejection pitches during foreseen catastrophic rolls, spins or spin and roll movements, impacts and collisions of a failed aircraft. Additionally, as depicted in the preferred embodiment, the lateral ejection apparatus affixes to any aircraft seat or seat platform by means of an integrated construction system mold constituting the flange and drillable top outer surface of the monorails outer track box. The seat chassis and outer track box are prevented from moving along the wheel trucks of the inner monorails by the rocket catapults secured to the protective blast shield. This connection between the catapults and the blast shield, secures the seat chassis in position on the tracks until when the catapults burst the connection seals upon ignition of the ejection sequence. Deployable head, neck and chest airbags along both sides of the seat chassis and for positioning the legs and torso for safe ejection are necessary to the invention. The rocket propelled greater sliding door panel with an interior fixed conventional hinge door has a pair of adequate pneumatic devices at the top and bottom of the sliding greater emergency door panel; with two common latch catches to prevent the sliding door panel from recoiling into the path of the ejecting seat chassis. At least three cylindrical compartments, which attach horizontally to the back of a seat chassis, and contain three altitude appropriate parachutes with a hermetically sealed sensor fuse box are optimal with this invention. The sliding door is configured to open only during an emergency ejection sequence, while the conventional hinge type door is the operational door for use by pilots or occupants. To anyone skilled in these arts, the features, objects, and advantages are obviously apparent, if not so already, but must be expounded while reading the proceeding detailed description of the invention, referring to the drawings.

ntional hinge door 33, and an exterior sliding door arm 32, located near the lower right corner of the sliding emergency greater door panel. 46, are the spring loaded latch catches to prevent the recoiling of the sliding greater door panel.

FIG. 2 is a side view of an aircraft occupancy, here a helicopter with a closed fixed emergency greater sliding door panel 34, and interior operational conventional hinge door 33.

FIG. 3 is a side view of the aircraft occupancy 37, and the fixed emergency greater sliding door panel 34, with interior operational conventional hinge door transversing the aircraft fuselage by means of pneumatic rockets 35,36. FIG. 3 also shows a seat chassis 38, as it is fitted onto triple monorail ejection devices FIG. 6., during the ejection sequence when the airbags 40,41, and the seat chassis, right side airbag 42.

### BRIEF DESCRIPTION OF THE DRAWINGS

FIG. 1 is a transparent side view of an aircraft occupancy, here a helicopter fuselage with two of the main lateral ejection components, triple monorails, mounted on the supporting track launcher platform legs in which the bottom tail fins are slotted.

FIG. 2 is a side view of an aircraft occupancy, here a helicopter with a closed fixed emergency greater sliding door panel, and interior operational conventional hinge door.

FIG. 3 is a side view of the aircraft occupancy, and the fixed emergency greater sliding door panel with interior operational conventional hinge door transversing the aircraft fuselage by means of pneumatic rockets.

FIG. 4 is a side view of the path of the laterally ejecting outer track box with attached seat chassis, after ejecting from the aircraft occupancy.

FIG. 5 is a side view of the laterally ejected devices initiating parachute extraction by means of standard drogue chute extraction, after the ejected apparattii have cleared the tail of the aircraft.

FIG. 6 is a side view of the main triple monorail components of the triple monorail lateral ejection method.

FIG. 7 is a side view of the outer track box to which any seat chassis can be mounted and is movable along the inner tracks and supporting tracks.

FIG. 8 is a side view of the triple monorails after the outer track box has been ejected, revealing the blast shield and catapult rocket base seals on the blast shield.

FIG. 9 is an anterior side perspective view of the triple monorails, showing the blast shield, and three monorail track support columns.

FIG. 10 is a transparent top, side or bottom view of the back monorail track.

FIG. 11 is a transparent top, side or bottom view of one of the two bottom positioned monorail tracks.

FIG. 12 is top view of the supporting track roller trucks configuration.

FIG. 13 is a top view of the corner elbow supporting track roller trucks configuration.

FIG. 14 is a top view of an aircraft seat with three parachute cylinders along the back.

FIG. 15 is a top transparent view of the hermetically sealed altitude appropriate parachute ignition fuse box.

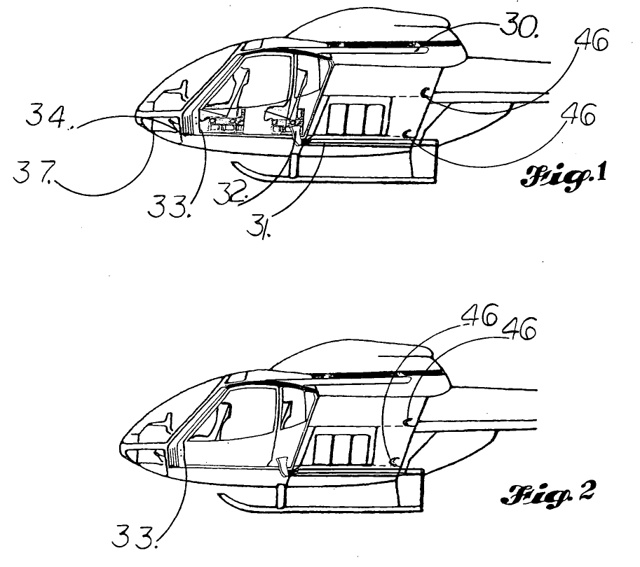

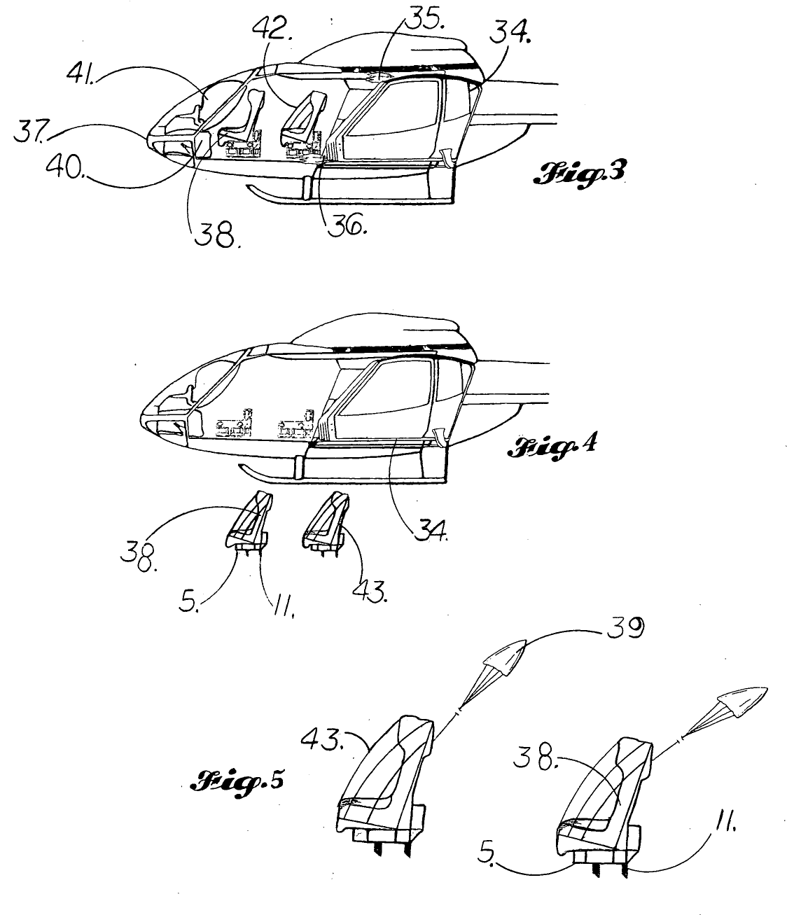

### DETAILED DESCRIPTION OF THE INVENTION AND DRAWINGS

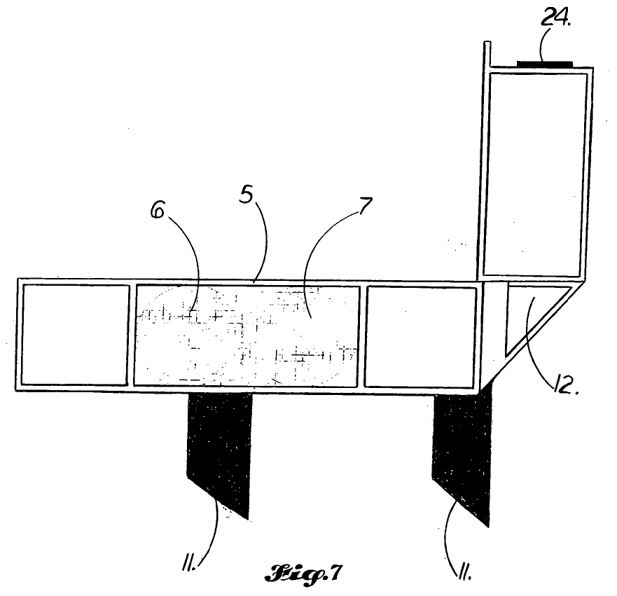

FIG. 1 shows an aircraft occupancy, in this instance that of a helicopter having a fuselage 37, which is large enough to be fitted with two triple monorail ejection devices FIG. 6, on each side of the aircraft one behind the other. FIG. 1 is a transparent side view of an aircraft occupancy, here a helicopter fuselage with two of the main lateral ejection components FIG. 6, triple monorails, mounted on the supporting track launcher platform legs 9, in which the bottom tail fins are slotted. The helicopter fuselage has a set of sliding door 34, tracks 30,31, an interior operational conve open simultaneous with the pneumatic rockets 35,36 transversing the emergency greater sliding door panel to the rear of the fuselage

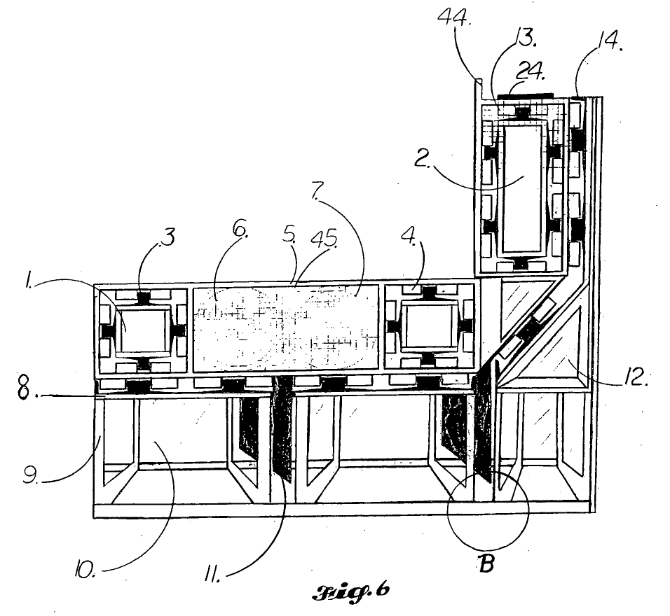

FIG. 4 is a side view of the path of the laterally ejecting outer track box 5, with attached seat chassis 38, after ejecting from the aircraft 4 occupancy, and guided towards clearing the tail of the aircraft by the outer track box 5, tail fins 11. The left side head, neck, and chest protector airbag 43, is shown with the right side airbag concealed behind it 42.

FIG. 5 is a side view of the laterally ejected devices initiating parachute extraction by means of standard drogue chute 39, extraction, after the ejected apparattii have cleared the tail of the aircraft. Similarly, to FIG. 4, FIG. 5 identifies the left side airbag 43.

FIG. 6 is a side view of the main triple monorail components of the triple monorail lateral ejection method, comprising two bottom monorails 1, and one monorail positioned at a right angle 2, to the bottom two monorails. Each monorail consists of wheel truck axel bases 3, and truck rollers 4. The monorails are surrounded by an outer track box 5, which is movable laterally along the triple monorails, and to which any seat may be attached by means of a flange 44, located at the top interior corner of the outer track box; and by a drillable surface 45, on the outer track box at the center of the lower top section of the outer track box. When bolting or welding at the drillable area 45, one must leave room for the two rocket catapults 6,7 which are housed in the rectangular area between the bottom two monorails and directly below the drillable surface area 45. FIG. 6 clearly shows the support track 8, including the corner elbow section 12, and the rubber knobs 14, which seal these tracks from open air contact, along with a mesh cloth cover 13, depicted partially and in transparency. The device further is supported on launcher platform legs 9, a blast shield 10, seen partially in FIG. 6, and divided such that two bottom mounted tail fins 11, are slotted between the platform legs. The area of circumference B, designates the angle, being the distance between the launcher platform legs in which the tail fins are slotted as the maximum angle the tail fins may exit the leg hole slots 24, is the hermetically sealed sensor fuse box attached by a rip cord to both the outer track box and the blast shield. The rip cord 26, FIG. 15, opens the hermetic seal of the sensor fuse box upon separation of the outer track box from the aircraft fuselage during ejection, allowing for a controlled triggering of the appropriate parachute.

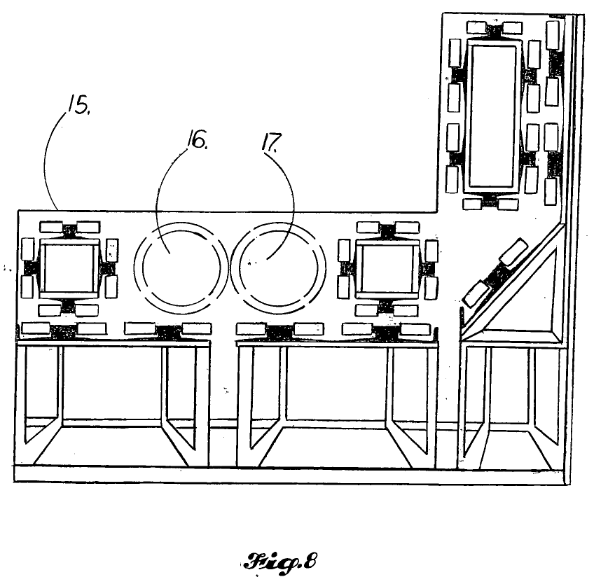

FIG. 7 is a side view of the outer track box5, to which any seat chassis can be mounted and is movable along the inner tracks and supporting tracks. The corner elbow right angle connector 12, which attaches the lower portion of the outer track box to the upper portion of the outer track box is a standard elbow coupling device of triangular right angle construction. Both tail fins can be seen in FIG. 7, in their unslotted posture, while the rocket catapults 6,7, are concealed behind the mesh cloth end cover. 24, FIG. 7, shows the sensor fuse box as attached to the outer track box after separation.

FIG. 8 is a side view of the triple monorails after the outer track box has been ejected, revealing the upper portion of the blast shield 15, and catapult rocket base seals 16,17 on the blast shield, and which base seals prevent the outer track box from moving or sliding on either the monorail inner tracks 1,2, or the support track 8. These two seals 16,17 are the only locking mechanism which prevent the outer track box from moving prior to ejection, and which seals are burst do to the ignighting of the rocket catapults and the combustion expansion within the seals which sheer this only locking connection between the launcher platform base and the movable outer track box.

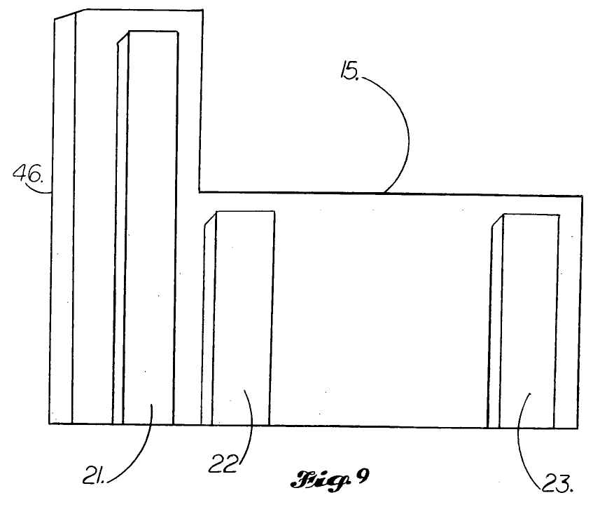

FIG. 9 is an interior side perspective view of the triple monorails, showing the blast shield 15, in its entirety, and three monorail track support columns 21, 22, 23. 46, is the back reinforcing panel of the launcher platform.

FIG. 10 is a transparent back view of the back monorail track 2, a cross sectional piece of the blast shield 15, and the roller truck wheel bases 3, supporting the roller truck wheels 4. FIG. 10, line C is a back side view of the back monorail track support column, and 21, FIG. 10 the same support column 21, as it looks next to the back reinforcing panel of the launcher platform 46.

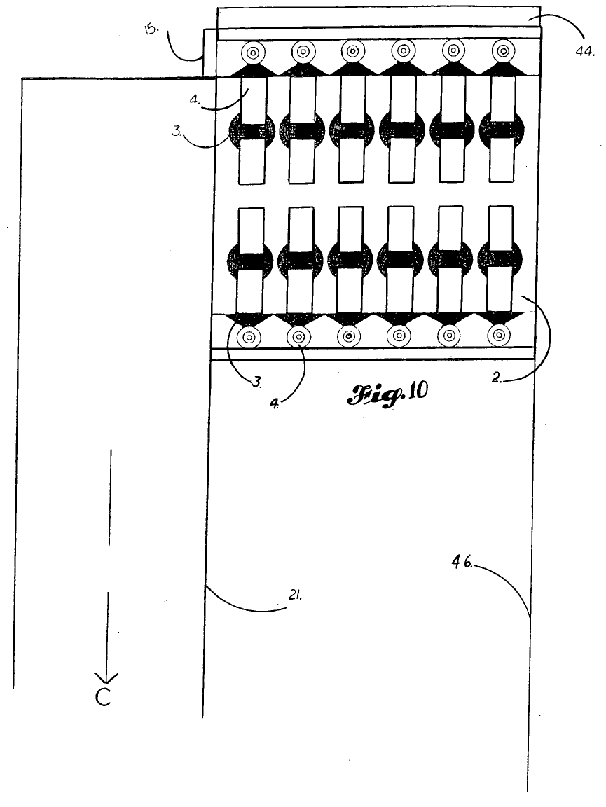

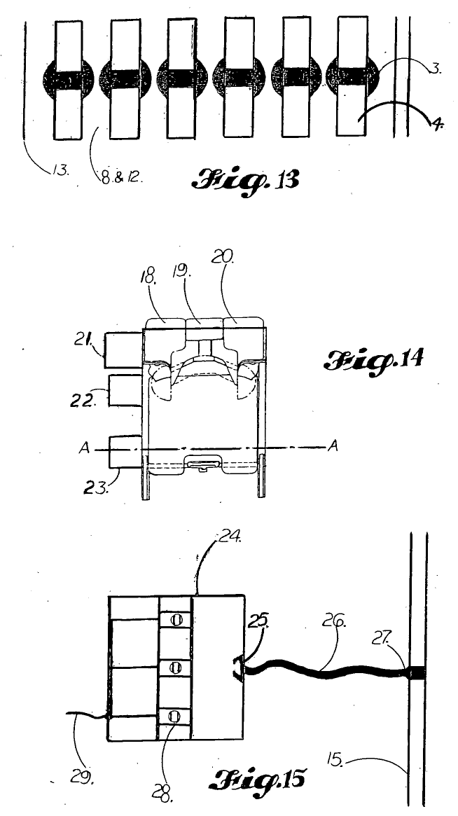

FIG. 11 is a transparent top, side or bottom view of one of the two bottom positioned monorail tracks 1, a cross sectional piece of the blast shield 15, a cross sectional of the mesh cloth end cover 13, the roller truck bases 3, and the roller truck wheels 4. Line A-A corresponds with line A-A of FIG. 14, and represents the positioning of the monorail lower front monorail track beneath the knee and thigh of the seat chassis occupant. 23 is a top view cross sectional piece of the bottom monorail track support column.

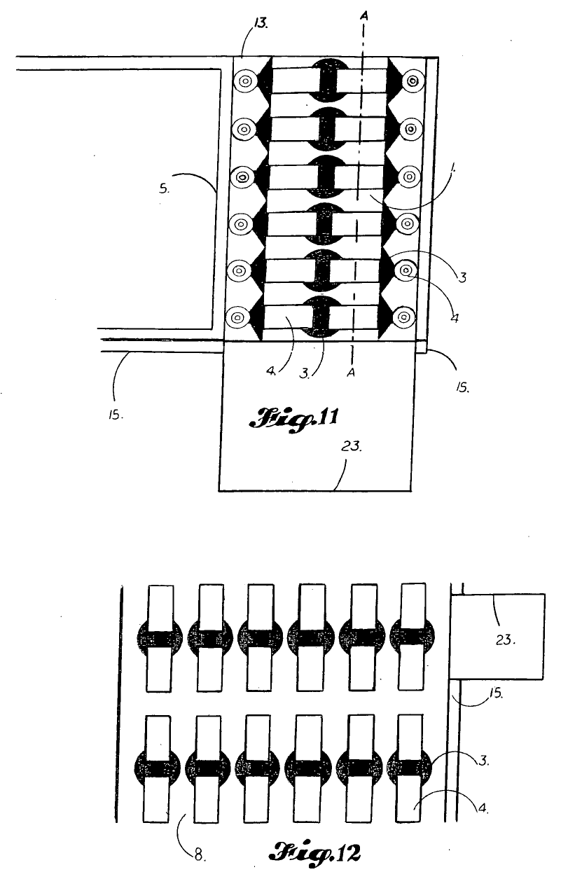

FIG. 12 is top view of the supporting track 8, roller trucks configuration 3, 4, which is identical to the roller trucks 3, 4, design used on the inner monorail tracks 1. Also shown is the joining abutment between the blast shield 15, and the support track 8. FIG. 12, 23 shows how the support column 23, intersects a portion of the supporting track roller truck alignment, and the other portion of the supporting track roller trucks is aligned perpendicular to the horizontal longitude of the blast shield.

FIG. 13 is a top view of the corner elbow 12, supporting track 8, roller trucks configuration 3, 4, and the mesh cloth end cover 13.

FIG. 14 is a top view of an aircraft seat with three parachute cylinders 18, 19, 20, along the back of the seat chassis. Line A-A is the position of the monorail track shown in FIG. 11, beneath the knee and thigh of the seat chassis occupant. 21, 22, 23, are top views of the inner monorail tracks support columns.

FIG. 15 is a top transparent view of the hermetically sealed 25, altitude appropriate parachute ignition fuse 28, box 24, which is connected to the blast shield 15, by a rip cord 26, and rip cord base 27, that pull the hermetic seal 25, from the fuse box 24, upon ejection of the outer track box from an aircraft to which the fuse box can be attached on the top outer portion of the back portion of the outer track box. 29 is the ignition wire for the three altitude appropriate parachutes 18, 19, 20.

1. The method for producing lateral ejection apparattii for helicopter or plane comprising;
An aircraft occupancy, shown here as a helicopter with a set of seat chassis' mounted on a set of rails of any type, ideally depicted on load bearing triple monorails. Load bearing triple monorails with one-hundred sixty-eight circumventing roller trucks attached to the inner rails, and covered along the barrel end by mesh; an outer track box movable along the seat tracks; A monorail supporting track with eighty-four roller trucks; An outer track movable box to which any seat chassis or chassis' can be mounted, and ejected laterally, perpendicular to the horizontal longitudinal axis of an aircraft, and guided out of the path of a failed aircraft during ejection flight by two bottom positioned tail fins slotted within the ejection monorails launcher platform legs; A seat chassis able to eject laterally by the opening of an emergency pneumatic rocket propelled fixed greater sliding door panel, in which, a operational conventional hinged door is housed; An emergency fixed greater sliding door panel with pneumatic rockets located at the top and bottom of the sliding panel, which design is prevented from recoiling into the path of the ejecting occupant and device by a common latch; Two sets of dual airbags for positioning the legs and torso and protecting the head, neck and chest of the ejecting occupant, and which are mandatory for safe lateral equal access emergency exit ejection; Three compartments for altitude appropriate parachutes; A hermetically sealed fuse box with a rip cord attached to the blast shield in which altitude sensitive fuses for opening the desired altitude appropriate parachutes are contained; A anterior side mounted blast shield and monorail inner track support to which a pair of ejection catapult rockets are sealed until ignited, thereby preventing the outer track box and seat chassis from moving along the inner and supporting tracks.

2. The method for producing lateral ejection apparattii for helicopter or plane of claim 1, where a set of tracks are constructed laterally or perpendicular to the horizontal longitudinal axis of an aircraft occupancy.

3. The method for producing lateral ejection apparattii for helicopter or plane of claim 2, where a set of three monorail tracks are constructed in a right angle configuration with two monorails forming a base to which the third or back monorail is aligned.

4. The method for producing lateral ejection apparattii for helicopter or plane of claim 3, where a set of triple monorails are surrounded by an outer track box to which any seat chassis can be mounted, and which is movable along the monorail inner tracks and launcher platform supporting track structure.

5. The method for producing lateral ejection apparattii for helicopter or plane of claim 4, where an ejection outer track box which can attach to any seat chassis is prevented from moving along the monorail and supporting tracks prior to the lateral ejection sequence by burst able seal locks connecting two rocket catapults housed within the outer monorail track ejection box between the bottom monorail inner track casing to a blast shield joined to three support columns, supporting the triple monorail inner tracks with attached roller trucks.

6. The method for producing lateral ejection apparattii for helicopter or plane of claim 2, where a pair of tail fins are arranged beneath a seat chassis in order to guide the seat chassis after ejection on a curved path away from the roll and spin area of a failed aircraft.

7. The method for producing lateral ejection apparattii for helicopter or plane of claim 6, where the bottom mounted tail fins which guide the ejecting seat chassis trajectory, and are attached to an outer monorail track box to which any seat chassis may be fixed.

8. The method for producing lateral ejection apparattii for helicopter or plane of claim 7, where the bottom mounted tail fins attached to the outer monorail track box are slotted within legs of a launcher platform, which platform further supports a supporting track supporting both the outer and inner monorail tracks.

9. The method for producing lateral ejection apparattii for helicopter or plane of claim 2, where an emergency greater sliding door panel with an interior operational conventional hinge door is propelled out of the path of the ejecting occupants by pneumatic rockets located at the top and bottom of the front interior portion of the sliding greater door panel, and prevented from recoiling into the path of the ejecting occupants by a set pair of latch catches located on the side of the aircraft fuselage between the upper and lower sliding door panel tracks.

10. The method for producing lateral ejection apparattii for helicopter or plane of claim 2, where multiple airbags are employed for positioning the legs, torso and head of an occupant, and dual side seat chassis airbags to protect the head, neck and chest of an occupant while laterally ejecting from an aircraft by means of rocket catapult propulsion.

11. The method for producing lateral ejection apparattii for helicopter or plane of claim 2, where at least three compartments for altitude appropriate parachutes are affixed to the ejecting seat chassis.

12. The method for producing lateral ejection apparattii for helicopter or plane of claim 2, where at least three altitude appropriate parachutes are controlled by a hermetically sealed sensor fuse box that can be mounted on the top outer portion of the back outer monorail track, and activated by a simple rip cord fixed to the interior of the aircraft or a blast shield, which rip cord upon ejection opens the hermetic seal of the parachute fuse box, exposing multiple altitude sensitive fuses to altitude pressures; whereby the appropriate parachute drogue extraction is commenced in sequence.

13. The method for producing lateral ejection apparattii for helicopter or plane of claim 2, where a blast shield is placed in the interior or the aircraft to both facilitate ejection rocket launch, and to prevent the after burn of the rocket catapults from destroying or harming the occupants and devices on the opposite side of the aircraft; also employing a blast shield for lateral ejection.

14. The method for producing lateral ejection apparattii for helicopter or plane of claim 1, where any seat chassis has at least three compartments attached to the back of the seat chassis and contain at least three altitude appropriate parachutes for safe lateral ejection.

15. The method for producing lateral ejection apparattii for helicopter or plane of claim 3, where three monorail tracks are constructed such that the inner monorail tracks support an outer monorail track box which moves along the inner monorail tracks by means roller truck wheels.

16. The method for producing lateral ejection apparattii for helicopter or plane of claim 4, where the supporting track structure of the launcher platform employs roller truck wheels to support the movable outer track box and inner tracks.

17. The method for producing lateral ejection apparattii for helicopter or plane of claim 3, where three monorail tracks are supported by three support columns located on the interior of the aircraft and molded to the inner monorail tracks at right angles.

18. The method for producing lateral ejection apparattii for helicopter or plane of claim 3, where the triple monorail tracks are supported by a launcher platform base support track, three support columns molded to the inner monorail tracks interior ends, and by a blast shield molded to the launcher platform, support track, and three support columns.

19. The method for producing lateral ejection apparattii for helicopter or plane of claim 3, where an aircraft fuselage, including helicopters and planes is large enough to accommodate multiple lateral ejection devices without reducing the number of occupant accomadations.

20. The method for producing lateral ejection apparattii for helicopter or plane of claim 2, where an aircraft fuselage has either the design changed or number of occupant accommodations reduced in order to install lateral ejection devices.
